(19) United States
(12) Patent Application Publication
(10) Pub. No.: US 2009/0113090 A1
(43) Pub. Date: Apr. 30, 2009

(54) KEYBOARD

(76) Inventors: Gerhard HOCHGESANG, Bad Neustadt/Saale (DE); Klaus Schmoeger, Bad Neustadt (DE)

Correspondence Address: Muncy, Geissler, Olds & Lowe, PLLC, P.O. BOX 1364, FAIRFAX, VA, 22038-1364, US

(21) Appl. No.: 12/264,612

(22) Filed: Nov. 4, 2008

Related U.S. Application Data
(63) Continuation of application No. PCT/EP2007/003750, filed on Apr. 27, 2007.

(30) Foreign Application Priority Data
May 4, 2006 (DE) 10 2006 020 701.7

(51) Int. Cl. G06F 3/00

(52) U.S. Cl. 710/63

(57) ABSTRACT

A keyboard is provided with at least one keypad, a housing, and at least one USB port, wherein the USB port is located behind an opening in a top of the housing and the opening is at least partially closed by a dirt and/or dust protector.

This nonprovisional application is a continuation of International Application No. PCT/EP2007/003750, which was filed on Apr. 27, 2007, and which claims priority to German Patent Application No. DE 102006020701, which was filed in Germany on May 4, 2006, and which are both herein incorporated by reference.

### BACKGROUND OF THE INVENTION

1. Field of the Invention

The present invention relates to a keyboard with at least one keypad, with a housing, and with at least one USB port in the housing.

2. Description of the Background Art

A keypad typically has a housing which has on its top an opening through which projects at least one keypad that can be operated by a user. Letters, numbers, or symbols, for example, can be selected by means of the keypad, or the keys of the keypad can be assigned control functions. In this context, the keyboard is directly or indirectly connected to an associated computer. The connection here can take place by means of a wire or wirelessly. It is known to equip the keyboard with connections for external devices or card readers along with the keypads on the top of the keyboard.

A keyboard with an integrated card reader is known from DE 103 45 606 A1. The point-of-sale (POS) keyboard described therein has a housing with at least one keypad and an integrated card reader. The card reader here is protected from dust or dirt by brushes that are located on two sides above an opening in the housing and that rest lightly against one another.

Moreover, there is known from DE 20 2005 008 474 U1 a keyboard that has on its top a port complying with the USB (universal serial bus) standard by means of which the keyboard can be connected to a variety of external devices. The purpose of this keyboard is to provide a keyboard with which the transmission and reception of speech is simplified.

In addition to a USB interface, a wide variety of connections for external devices, such as microphones or headphones, for example, are provided in the keyboard.

The use of USB interfaces in keyboards is generally known, and moreover is described in DE 199 46 704 A1, which corresponds to U.S. Pat. No. 6,264,385, and DE 201 04 939 U1. The integration of USB interfaces in the sides of the housing of the keyboard is described.

Since the keyboards described are also used in extremely dirty environments and are thus subject to dirt accumulation, the object of the invention is to provide a keyboard, or a housing for a keyboard, that makes it possible to use such keyboards even in areas subject to severe dirt accumulation or the effects of dust. Possibilities here include, for example, workshops or other workplaces that are subject to severe contamination by dust.

### SUMMARY OF THE INVENTION

It is therefore an object of the present invention to provide a USB port in a housing of a keyboard that is located behind an opening in a top of the housing and in that the opening is at least partially closed by a dirt and/or dust protector. The inventive design of a keyboard now makes it possible to provide a conventional keyboard with a USB interface that is easily accessible to the user and also protected from dirt. A wide variety of options for sealing the USB port are possible according to the advantageous variant embodiments of the invention described in the dependent claims. For light-duty dust protection, it is possible in this regard to provide the opening in the housing behind which the USB port is located with brushes arranged on one or both sides of the housing, thus protecting the port. For heavy dirt accumulation or contamination by environmental influences, it is possible to seal the opening in the housing by, for example, a roller shade, sealing lips, or a flap.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a keyboard in a top view, according to an embodiment; and

FIGS. 2a-2d illustrate a section A-A from FIG. 1 in various embodiment variants.

### DETAILED DESCRIPTION

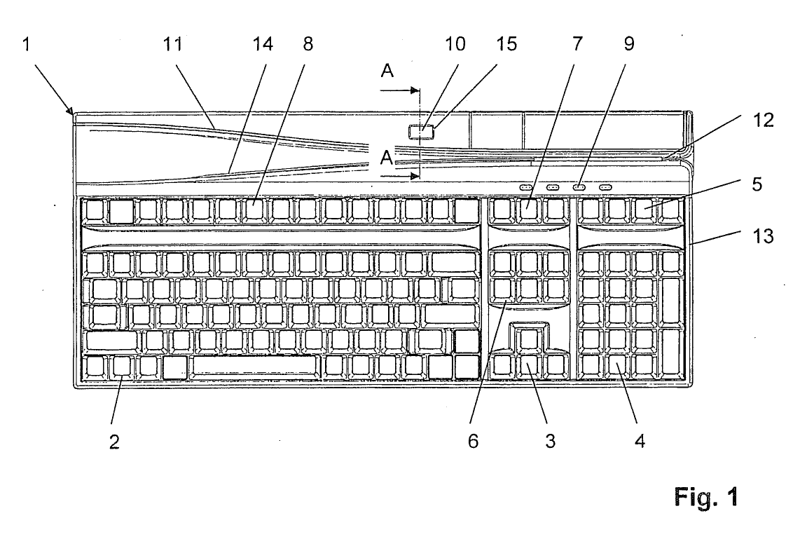

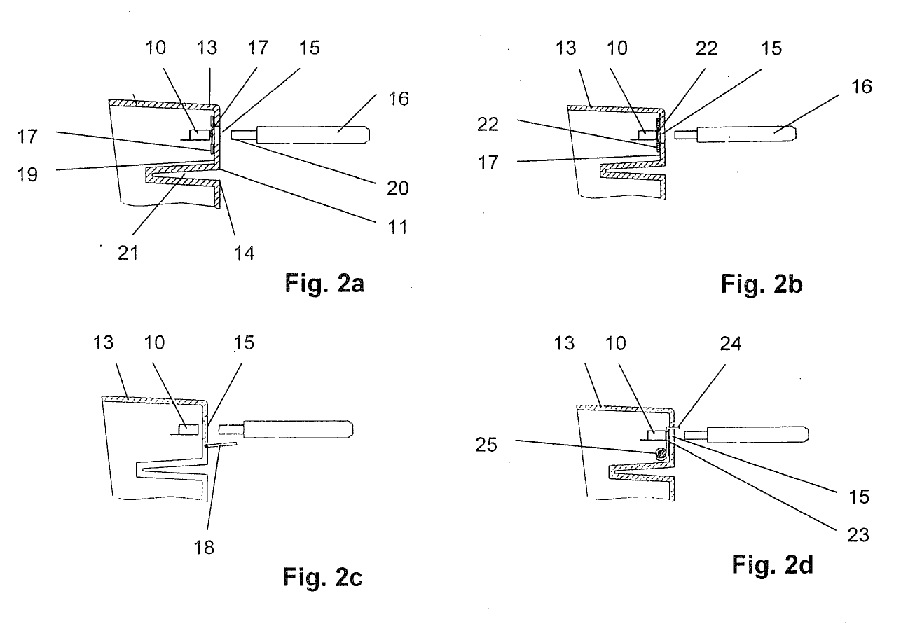

FIG. 1 shows a top view of a keyboard 1. The keyboard exhibits a conventional keyboard with a keypad 2 primarily for entry of letters, a cursor area 3, a keypad 4 for entry of numbers, and various keypads 5, 7, and 8 with keys for control functions. Also integrated into the keyboard 1 are illuminating means 9 that indicate various functions such as the operational readiness of the numeric field 4, for example. A USB port is present on the top of the keyboard 1 above the keypads. Only one USB port 10 is shown; however, it is also possible according to the invention to arrange multiple USB ports 10 next to one another or distributed over the top or bottom of the keyboard. The swept shape of the line 11 can be purely esthetic in nature, but it is also advantageous to provide the keyboard 1 with a card reader in the area 12. The card here would then be passed through the keyboard housing 13 by means of the swept line 11. The passage of a magnetic card is also clearly visible in cross-section according to FIGS. 2a through 2d. In this regard, the swept areas are labeled 11 and 14 in FIGS. 1 and 2a.

Located in the housing 13 of the keyboard 1 is an opening 15 behind which the USB port 10 is arranged. As is clearly evident from FIG. 1, the opening 15 is directly subject to dirt accumulation; since it is arranged on the top of the keyboard 1, and since the keyboards are customarily placed nearly horizontal on a support, direct entry of dust and dirt is possible. This is prevented by the inventive use of a dust and dirt protector.

An additional advantage resulting from the arrangement of a dust protector is that the plug to be plugged into the USB port, which can be a USB stick or a USB device or a USB cable 16, for example, is cleaned of dust and dirt by brushes 17 arranged above the USB port 10. Reference is made hereby that a combination of, e.g., a flap 18 located over the opening and a brush 17 is also possible according to the invention.

Various variant embodiments, some of which can be used in combination, are reproduced by way of example in FIGS. 2a, 2b, 2c and 2d.

In FIG. 2a, which shows a section along the line A-A from FIG. 1, it can be seen that the USB port 10 is arranged behind an opening 15 in the housing 13 of the keyboard 1. Brushes 17 are fastened on both sides behind the opening 15 on the inside 19 of the housing. The fastening is accomplished by means of pressing, gluing or other fastening methods, wherein the brushes 17 can also be introduced into the housing 13 during the injection molding of the housing 13. A USB stick 16 is shown here with a plug 20. The plug 20 is inserted into the USB port 10, and in the process must displace or push aside the bristles of the brush 17. Also evident in FIG. 2a is the guide 21 that is formed by the swept area 11, 14 of the housing 13 and through which can be guided, for example, a magnetic card (not shown), which can then be read by means of a magnetic card reader 12 in a rear area of the guide 21.

In FIG. 2b, sealing lips 22 are arranged behind the opening 15 in the housing 13. These sealing lips can be made of silicone, for example. In FIG. 2c, the dust and dirt protector is composed of a flap 18 that is fastened to the housing 13 in a pivoting manner. The arrangement of a flap 18 in front of the opening 15 also has the advantage that information for the user can be placed on the flap 18. In addition, the keyboard 1 can also be protected from severe mechanical stresses or massive dirt accumulation through the use of a flap 18. In FIG. 2d, the dust and dirt protector is composed of a roller shade 23 located in front of the USB port 10. Formed on the rollable area 23 of the roller shade 23 is an extension 24 by means of which the user can move the roller shade to expose the opening 15. In this embodiment, the roller shade 23 is rolled up by means of a shaft 25 to which the roller shade 23 is fastened. To this end, the shaft 25 is rotatably held in the housing 13. Furthermore, the dust and dirt protector can be lockable.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A keyboard comprising:
at least one keypad;
a housing; and
at least one USB port, the USB port being arranged behind an aperture in a top of the housing, the aperture being substantially closeable by a dirt or dust protector, wherein the aperture is configured to be completely closeable for preventing dirt or dust from accumulating onto the USB port.

2. The keyboard according to claim 1, wherein the dirt or dust protector is formed by a sealing lip fastened to the housing on one or both sides of the housing, and wherein the sealing lip is made of silicone.

3. The keyboard according to claim 1, wherein the dirt or dust protector is formed by a flap that is fastened to the housing in a pivoting manner.

4. The keyboard according to claim 1, wherein the dirt and/or dust protector is formed by a brush fastened to the housing on one or both sides.

5. The keyboard according to claim 1, wherein the dirt or dust protector is composed of a roller shade attached to the housing in an openable manner.

6. The keyboard according to claim 1, wherein the USB port is located above or below the keypad.

7. The keyboard according to claim 1, wherein at least one card reader is integrated into the keyboard, and wherein the card reader is fastened behind an additional opening and/or a pass-through slot in the housing.

8. The keyboard according to claim 7, wherein the opening for the additional card reader is provided with an additional dirt and/or dust protector.

9. The keyboard according to claim 1, wherein the dirt or dust protector is lockable.
